(19) United States
(12) Patent Application Publication
(10) Pub. No.: US 2023/0177427 A1
(43) Pub. Date: Jun. 8, 2023

(54) METHOD FOR MONITORING A CONSTRUCTION SITE AND SYSTEM RELATED THERETO

(71) Applicant: FIELDDATA.IO GmbH, München (DE)

(72) Inventors: Hans REGLER, Schrobenhausen (DE); Jochen MAURER, München (DE)

(21) Appl. No.: 17/924,133

(22) PCT Filed: May 12, 2021
(86) PCT No.: PCT/EP2021/062667

§ 371 Date: Nov. 9, 2022

(30) Foreign Application Priority Data
May 15, 2020 (EP) 20174938.9

(51) Int. Cl. G06Q 10/0631; G06Q 50/08

(52) U.S. Cl. CPC G06Q 10/06313; G06Q 50/08

(57) ABSTRACT

The invention relates to a method for monitoring a construction site, wherein several devices are used on the construction site and on each device at least one sensor is provided. A device list is created for each construction site to be monitored, wherein the several devices that are used on the respective construction site to be monitored are assigned to the device list of the construction site. Furthermore, for each device of the device list assignment is made as to which of the sensors provided on the device are assigned to the device list. To obtain the data from the sensors of the devices of the device list a direct or indirect communication connection is established with the devices of the device list. Finally, the data thus obtained from the sensors of the devices of the device list are stored in a specific, shared storage location. Furthermore, the invention relates to a system for monitoring a construction site.

### CROSS-REFERENCE TO RELATED APPLICATIONS

This application is a National Stage of International Application No. PCT/EP2021/062667 filed on May 12, 2021. This application claims the priority to European 20174938.9, filed on May 15, 2020. The entire disclosures of the above applications are incorporated herein by reference.

### FIELD

The invention relates to a method for monitoring a construction site and to a system for monitoring a construction site.

### BACKGROUND

The statements in this section merely provide background information related to the present disclosure and may not constitute prior art.

In large construction projects a plurality of construction devices and, to some extent, also sensors are used on a construction site. Coordination of the devices employed on a construction site is not easy and becomes more complicated and complex with an increasing size of the construction site.

To facilitate coordination, various construction methods are known. For instance, in EP 3 533 934 A1 a construction method is described in which foundation elements are produced in an excavation pit at predetermined working points by means of working devices. In this case, monitoring is carried out via a computer unit, thereby enabling the simultaneous operation of several working devices, with particular attention being paid to the necessary open spaces.

### SUMMARY

This section provides a general summary of the disclosure and is not a comprehensive disclosure of its full scope or all of its features.

The invention is based on the object to provide a method and a system which allow easy and efficient monitoring of a construction site.

In accordance with the invention this object is achieved by a method having the features of certain of the appended claims or claim, and by a system having the features of set forth in at least one of the appended claims.

Advantageous embodiments of the invention are stated in the subclaims, in the description as well as in the Figures and their explanations.

### BRIEF DESCRIPTION OF THE DRAWING

The drawing described herein is for illustrative purposes only of a selected embodiment and not all possible implementations, and therefore is not intended to limit the scope of the present disclosure.

FIG. 1 shows a schematic diagram to illustrate an exemplary embodiment of the method according to the invention.

### DETAILED DESCRIPTION

According to the invention provision is made in that in the method pursuant to the invention several devices are used on a construction site, wherein on each device at least one sensor is provided or mounted in each case. A device list is created for each construction site to be monitored, wherein the several devices that are used on the respective construction site to be monitored are assigned to the device list of the construction site. For each device of the device list, assignment is made as to which of the sensors present on the device are assigned to the device list. To obtain the data from the sensors of the devices of the device list, a direct or indirect communication connection is established with the sensors of the devices of the device list. The data thus obtained from the sensors of the devices of the device list are stored in a specific, shared storage location. It is also possible to calculate further information and/or determine statuses from the data obtained. These can then also be stored in the specific, shared storage location.

A basic idea of the invention can be seen in the fact that, for each construction site to be monitored, a dedicated device list is created and managed, in which it is noted, directly or indirectly, which devices with which sensors are present on the construction site and can supply data. By means of the content of this device list it is thus possible to clearly assign data supplied by sensors explicitly to a construction site and thereby optimize monitoring of this construction site. This is particularly expedient if several construction sites are to be monitored in parallel. By creating a device list for each construction site, in which note is taken of the utilized devices’ sensors that are to supply data, a large number of sensors can be managed and monitored simultaneously on different construction sites without requiring an increased effort to individually assign the data of the respective sensors to individual construction sites.

Furthermore, provision is made in that not every sensor provided on a device of the device list is assigned to the device list. If drilling devices that have a plurality of sensors are employed on a construction site, for example, the current oil level of the drilling device or the current status of other maintenance-related information, then such data may be of no relevance for the monitoring of the construction site. These data can therefore be excluded from the monitoring of the construction site. On the other hand, information, i.e., data, relating to the advancement speed during drilling or the like can indeed be of relevance and corresponding sensors can therefore be assigned to the construction site so that such data, in conjunction with data of other sensors information, can be used to determine the composition of the soil, for example.

Each sensor can be assigned directly. However, by means of the method according to the invention, constellations in which the assignment takes place in a more indirect way can also be taken into consideration. For example, it is possible that a device, e.g., a construction device, provides the data of its sensors as data of channels one to three. In this case, it is essential to know that the particular type of construction device supplies data on the depth of a bore on channel one, data on the required force on channel two and data on the filling level of the tank on channel three. These data can even be nondimensional and/or pure data of a sensor, e.g., a voltage value. In conjunction with the information as to which type of construction device is used, it is thus possible, in consideration of the channel number, to determine the corresponding physical quantity. In this case, too, the data of a sensor can be assigned via the corresponding channel.

According to the invention the data of the sensors of the devices of the device list are obtained via a direct or indirect communication connection to the sensors of the devices of the device list. On the one hand, a direct communication connection can be established with a sensor or to the corresponding device if the former or latter is designed for communication by means of a direct radio connection, for example. However, it is also possible to establish an indirect connection, e.g., via interconnected data collection points, which can be databases in a cloud or also local data collection points on a construction site.

Finally, the data obtained from the sensors of the devices of the device list are stored in a specific, shared storage location. In this way, a clear assignment of the data of the sensors of a device list to a construction site is rendered possible. This, in turn, facilitates a subsequent evaluation as well as the entire data management so that fewer resources have to be used for this purpose.

Advantageously, a working period is furthermore assigned to the device list of a construction site. Within the meaning of the invention, the working period can in particular be understood as the period of time in which works are scheduled to take place on a construction site. This time period, which is additionally defined in the device list, makes it possible to ensure that only those data of a sensor are stored in the specific, shared storage location that originate from the corresponding construction site. For example, if a construction device is moved from a first construction site to a second one, irrespective of whether a device list is also available for the second construction site, detection can already be made by means of the working period that the sensors no longer belong to the monitored construction site.

In this regard, provision can moreover be made in that the assignment of the sensors of a device to the device list is carried out by means of positional information, in particular in an automated manner. If the sensors are provided on a construction device it is, for example, possible that this construction device additionally receives positional information, e.g., by a GPS sensor. For instance, if the precise position or the dimensions and the position of a construction site are defined within the framework of the device list, the device and its sensors can, for example, be added in an automated manner to the respective device list as soon as corresponding positional information is on hand which indicates that the device is located on the construction site. It is also conceivable that an electronic registration is available on a construction site, to which an arriving construction device logs on.

Basically, the device list can be created at any point in time. However, it is advantageous if the device list is created before the beginning of the construction works. This ensures that all data of the sensors located on devices that are used on the construction site are reliably stored in the specific, shared storage. As a result, data management is again facilitated considerably and thereby more resource-efficient.

Basically, there are various possibilities to obtain data from the sensors of the devices of the device list. For instance, it is possible that the sensors of the devices of the device list actively transmit their data to a computing or evaluation unit that assigns the data of the sensors of the devices to a device list and ensures that these are saved in the specific, shared storage area. Transmission can in this case take place indirectly or directly, for example via intermediary points or also in a direct way by means of a local connection. Radio connections are, in principle, also suitable for this purpose.

Another possibility is that the data of the sensors of the devices of the device list are actively queried by the sensors and/or a database, in which these data are present. For example, this is possible if the data of the sensors are additionally stored in manufacturer-specific databases. This allows the data of the sensors to be queried at any point in time that can be defined within the framework of the method of the present invention. In principle, however, a combination of both types of procuring the data of the sensors can also be present.

It is preferred if construction devices and/or sensor means are used as devices. A construction device can be a diaphragm wall cutter or a pile driver, for example. As sensor means, for example load cells, can be used that are mounted on ground anchors in order to thereby monitor the forces arising.

Several device lists are created for several construction sites and used simultaneously, with respectively one device list being used for each construction site. It is precisely in such a constellation that the greatest advantage of the method according to the invention becomes apparent. This significant advantage is because the simultaneous monitoring of many construction sites is facilitated considerably by explicitly assigning sensors to a device list that corresponds to a construction site.

Furthermore, provision can be made in that by means of deleting a device list and/or the specific, shared storage location, the data relating to a construction site are deleted. This ensures that, after deletion, the data of the sensors of a construction site are no longer available at another place since the data were exclusively saved in the specific, shared storage location. This facilitates the increasingly important protection of data privacy.

Moreover, the invention relates to a system for monitoring a construction site having several devices that are used on the construction site. On each device at least one sensor is provided in each case. The system has an evaluation means, in which a device list is set up for each construction site to be monitored, wherein the several devices that are used on the respective construction site to be monitored are assigned to the device list of the construction site. In the device list note is taken for each device as to which of the sensors present on the device are included in the device list. The evaluation means establishes a direct or indirect communication connection with the sensors of the devices of the device list to obtain data from the sensors and subsequently store the data obtained from the sensors of the devices of the device list in a specific, shared storage location.

By way of the system according to the invention, it is thus possible to carry out the previously described method. As evaluation means the system can, for example, have a server which, by means of corresponding communication interfaces, actively or passively query the data of one or more of the sensors via a network, for instance the internet.

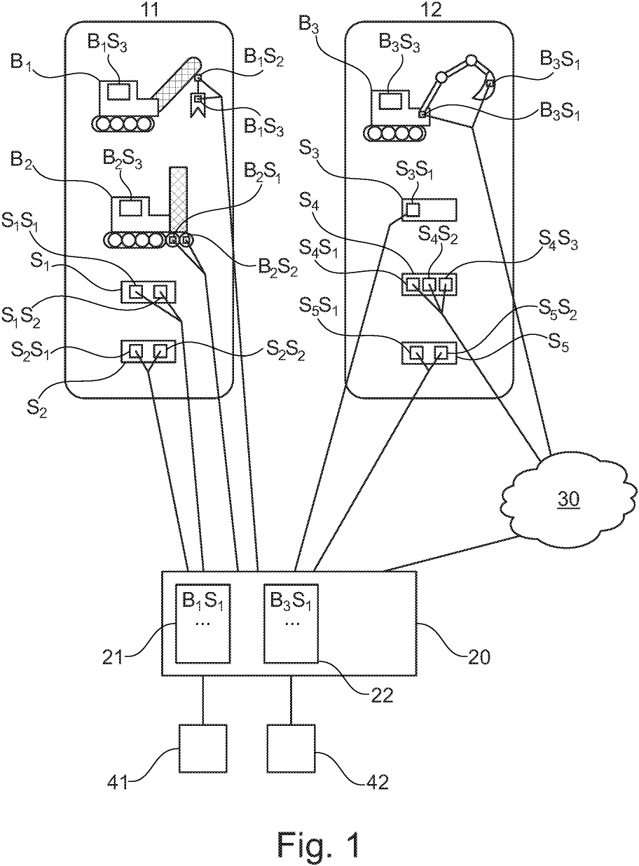

Referring now to FIG. 1, a first construction site 11 and a second construction site 12 are illustrated in a schematic manner.

On the first construction site 11 a construction device B₁ and a second construction device B₂ are used. Each of these construction devices B₁, B₂ has three sensors B₁S₁, B₁S₂, B₁S₃, B₂S₁, B₂S₂, B₂S₃. In this case, the sensors B₁S₃ and B₂S₃ supply data on the running time of the main engine after the last maintenance for example. By contrast, the sensors B₁S₁, B₁S₂, B₂S₁, B₂S₂ supply data e.g., on speeds of a shaft or data that allow conclusions as to the expenditure of force during ground removal.

In addition, on the construction site 11 two sensor means S₁ and S₂ are provided which each have two sensors S₁S₁, S₁S₂, S₂S₁, S₂S₂. These can be temperature sensors, seismic sensors or also load cells, for example.

Similarly, on the construction site 12 there are, in turn, a construction device B₃ with three sensors B₃S₁, B₃S₂ and B₃S₃ as well as three sensor means S₃, S₄ and S₅. In this case, each of these sensor means has one to three individual sensors S₃S₁, S₄S₁, S₄S₂, S₄S₃, S₅S₁, S₅S₂.

In the lower part of FIG. 1 an evaluation means 20 is illustrated, in which two device lists 21, 22 are set up.

On the device list 21 the sensors B₁S₁, B₁S₂, B₂S₁, B₂S₂, S₁S₁, S₁S₂, S₂S₁, S₂S₂ are entered. On the second device list 22, in turn, note is taken of the sensors B₃S₁, B₃S₂, S₃S₁, S₄S₁, S₄S₂, S₄S₃, S₅S₁, S₅S₂. The sensors B₁S₃, B₂S₃ and B₃S₃ are not on any of the device lists 21, 22.

The evaluation means 20 can now query data of the sensors of the sensor means S₄ and of the construction device B₃ via a cloud 30, for example. A direct query of the sensors of the construction device B₁ or B₂ is possible in a similar way. However, it is also possible that the sensors, e.g., the sensor S₁S₁, transmit its data independently to the evaluation means 20.

In the evaluation means 20 it is decided, based on the device lists 21, 22, in which specific shared storage 41, 42 the respective data of the sensors B₁S₁, B₁S₂, B₂S₁, B₂S₂, B₃S₁, B₃S₂, S₁S₁, S₁S₂, S₂S₁, S₂S₂, S₃S₁, S₄S₁, S₄S₂, S₄S₃, S₅S₁, S₅S₂ are to be saved. Data of the sensor B₁S₃ would, as the latter is not entered in any of the device lists 21, 22, not be stored in a specific, shared storage 41, 42, even if the sensor B₁S₃ were to transmit them to the evaluation means 20.

Thus, the invention enables targeted monitoring of data from different construction sites while at the same time simplifying the necessary monitoring structure.

1-11. (canceled)

12. A method for monitoring at least one construction site, comprising:
providing a plurality of devices which are used on the construction site, wherein each one of said devices has at least one sensor and generates data pertaining to a feature of operation of its associated said device;
creating a device list for the construction site prior to, or at a beginning of, construction operations at the construction site;
assigning each one of the plurality of devices to the device list;
further assigning one or more sensors from at least two of said plurality of devices to the device list;
creating a communications link with the sensors assigned to the device list;
creating a plurality of shared storage locations for receiving and storing the data generated by the one or more of the sensors of each said device which are assigned to the device list; and
selectively storing the data generated by different ones of the sensors assigned to the device list in a specific selected ones or ones of the shared storage locations.

13. The method of claim 12, further comprising assigning a working time period to the device list for each one of said devices.

14. The method of claim 12, wherein assigning of the one or more sensors of each one of said devices to the device list is based on positional information associated with the device of each said sensor, and in an automated manner.

15. The method of claim 12, where each of the sensors transmit their data to a computing unit which assigns the data of the sensors to one or more of the device lists.

16. A method for monitoring several construction sites, wherein a plurality of devices are used on each construction site, and wherein on one of said plurality of devices includes at least one sensor, the method comprising:
creating a device list for each said construction site to be monitored so that several device lists are simultaneously created for the construction sites;
wherein the device lists are created before construction begins at the construction site;
wherein the several devices that are used on the respective construction site to be monitored are assigned to the device list of the construction site;
wherein for each device of the device list assignment is made as to which of the sensors provided on the device are assigned to the device list,
wherein not every sensor provided on a device of the device list is assigned to the device list,
wherein for the purpose of obtaining the data from the sensors of the devices of the device list a direct or indirect communication connection is established with the sensors of the devices of the device list;
wherein the data obtained from the sensors of the devices of the device list are in each case stored in a specific, shared storage location; and wherein based on the device lists it is decided in which specific, shared storage location the respective data of the sensors are stored.

17. The method according to claim 16, wherein in a working period is assigned to the device list of a construction site.

18. The method according to claim 16, further comprising carrying out the assignment of the sensors to the device list using positional information, in an automated manner.

19. The method according to claim 16, wherein an unambiguous assignment between sensors of a device and a construction site takes place using the device list.

20. The method according to claim 16, wherein data of the sensors of the devices of the device list are queried by the sensors and/or a database, in which the data are present.

21. The method according to claim 16, wherein the of the devices of the device list transmit their data to a computing unit which assigns the data of the sensors of the devices to the device list.

22. The method according to claim 16, wherein the devices comprise construction devices.

23. The method according to claim 16, wherein as devices, sensor means are used.

24. The method according to claim 1, further comprising deleting a device list and/or the specific, shared storage location, which causes the data relating to a construction site to be deleted.

25. A system for monitoring a plurality of construction sites each having a plurality of devices which are being used on the plurality of construction sites, and wherein each said device has at least one sensor which generates data associated with operation of its associated device, the system comprising:
an evaluation means;
a plurality of shared storage subsystems located at a corresponding plurality of shared storage locations;
the evaluation means configured to:
use a separate device list which is created for each one of said construction sites to be monitored so that a plurality of device lists are created, one said device list being associated with a single one of plurality of construction sites;
wherein the plurality of devices that are used on the construction sites to be monitored are assigned in at least one of the device lists (21, 22) of the construction sites;
wherein the device lists are created before, or at the beginning of, work at the construction sites;
wherein in each said device list, an assignment is made for each said device as to which one or more, if any, of the sensors present on each said device is/are assigned to a specific one or more of the device lists;
wherein the evaluation means is further configured to establish a communication link with the sensors of the device list to obtain data from the sensors; and
wherein the evaluation means stores the data obtained from the sensors of the device list in each case in at least one of the plurality of shared storage locations; and
wherein based on the device lists, the evaluation means decides in which specific, one of the shared storage locations the respective data of the sensors is/are to be stored.
